(19) United States
(12) Patent Application Publication
(10) Pub. No.: US 2004/0125906 A1
(43) Pub. Date: Jul. 1, 2004

(54) Container for heat-generating radioactive elements

(75) Inventors: Konrad Gluschke, Wickede (DE); Wolfgang Hawickhorst, Essen (DE)

Correspondence Address: THE FIRM OF KARL F ROSS, 5676 RIVERDALE AVENUE, PO BOX 900, RIVERDALE (BRONX), NY, 10471-0900, US

(73) Assignee: GNB Gesellschaft fur Nuklear-Behalter mbH

(21) Appl. No.: 10/695,629

(22) Filed: Oct. 28, 2003

(30) Foreign Application Priority Data
Nov. 9, 2002 (EP) 02025146.8

(51) Int. Cl. G21C 19/00

(52) U.S. Cl. 376/272

(57) ABSTRACT

A transport/storage container for heat-generating nuclear-fuel elements has spaced inner and outer side walls defining an annular space extending along an axis and having upper and lower ends. A cover is provided at the upper end and a floor at the lower end. A plurality of axially extending and angularly spaced heat-conducting metal tubes each have an inner wall section bearing in surface contact on an outer surface of the inner side wall and an outer wall section bearing in surface contact on an inner surface of the outer side wall. A concrete mass fills the space.

### FIELD OF THE INVENTION

The present invention relates to container. More particularly this invention concerns a storage/transport container for heat-generating radioactive elements, e.g. spent nuclear-fuel rods.

### BACKGROUND OF THE INVENTION

A transport/storage container for spent nuclear-fuel elements normally has spaced steel inner and outer side walls defining an annular space extending along an axis, a cover at one end of the side walls, a floor at an opposite end of the side walls, and a filler such as concrete in the space between the inner and outer side walls. Normally such a container is cylindrical and its interior is filled with heat-evolving radioactive waste, normally spent fuel rods.

In order to transmit heat from the inner walls to the outer walls, it is standard to provide radial heat-transmitting struts. Thus as described in U.S. Pat. No. 6,438,190 the metal elements are formed by webs of at least one open meander ring having the connecting webs which alternately contact the inner and outer side walls under prestress. Due to the necessary close tolerances observed, the manufacture and installation of these meander rings is very complicated. In addition, the cask has an excessively high mass for the ultimate waste disposal, and a reduction in mass by stripping the cask wall down to the inner casing can only be achieved with great difficulty. This applies, in particular, to instances in which the meander rings are also welded to the inner casing.

As described in U.S. Pat. No. 56,389,093 elastically deformable metal elements are used as heat-transmitting webs in another known transport/storage cask for heat-generating radioactive elements. However, this does not eliminate the aforementioned stripping problems because the metal webs are welded to the inner wall and/or the outer wall with at least one of their two ends.

### OBJECTS OF THE INVENTION

It is therefore an object of the present invention to provide an improved storage/transport container for radioactive elements.

Another object is the provision of such an improved storage/transport container for radioactive elements which overcomes the above-given disadvantages, that is which can be manufactured with ease and that produces a container that can easily be stripped down to the inner wall if necessary.

### SUMMARY OF THE INVENTION

A transport/storage container for heat-generating nuclear-fuel elements has according to the invention spaced inner and outer side walls defining an annular space extending along an axis and having upper and lower ends. A cover is provided at the upper end and a floor at the lower end. A plurality of axially extending and angularly spaced heat-conducting metal tubes each have an inner wall section bearing in surface contact on an outer surface of the inner side wall and an outer wall section bearing in surface contact on an inner surface of the outer side wall. A concrete mass fills the space.

According to the invention, the use of metal tubes significantly simplifies manufacture and assembly of the containers. For example, the tubes can be reduced with respect to their radial dimensions by spreading them and inserting them when spread the inner wall and the outer wall. After the stress is relieved, the tubes press against the inner wall and the outer wall under prestress. Since no rigid connections are produced between the inner wall, the tubes, the outer wall, and the filler, all components can be successively removed down to the inner wall in a relatively simple fashion and reclaimed.

The tubes according to the invention have radially extending wall sections that are elastically deformed. Thus these elastically deformed wall sections, which are somewhat arcuate rather than perfectly planar, hold the inner and outer wall sections in good heat-conducting contact with the inner and outer side walls.

To ensure best surface contact and conformation to the shape of the inner and outer walls, the inner and outer wall sections of the tubes are soft annealed.

The tubes are of quadrilateral cross section. Once installed, of course, the inner and outer wall sections are somewhat arcuate, as are the radially extending connections sections, but the shape is still four-sided. The tubes extend generally a full axial length of the space and each of the inner and outer wall sections has a curvature complementary to a curvature of the respective inner and outer side wall.

In accordance with the invention the tubes are angularly equispaced. Axially extending and angularly spaced spacer strips are fixed to the outer surface of the inner wall between the tubes to hold them in place, but no weld or bolt connections otherwise used.

The inner and outer surfaces have a release-agent coating, typically an epoxy lacquer. This makes it possible to strip off the outer side wall, concrete filler, and tubes with relative ease.

The floor according to the invention comprises an inner floor panel and an outer floor panel spaced axially therefrom and the tubes each have a pair of generally radially and axially extending wall sections. L-shaped connector strips each have one end fixed to an outer surface of the inner floor panel and an opposite end secured by a respective clip to a respective one of the radially extending wall sections of the tubes.

### BRIEF DESCRIPTION OF THE DRAWING

The above and other objects, features, and advantages will become more readily apparent from the following description, reference being made to the accompanying drawing in which:

FIG. 1 is a small-scale axial section through a container according to the invention;

FIG. 2 is a larger-scale section taken along line II-II of FIG. 1;

FIG. 3 is a section taken along line III-III of FIG. 2; and

FIGS. 4 and 5 are cross-sectional details through another container according to the invention as it is being assembled.

### SPECIFIC DESCRIPTION

As seen in FIGS. 1 to 3 container for heat-generating radioactive elements, in particular for spent reactor fuel elements, basically consists of a cylindrical side 2 that delimits an interior space 1, a container floor 3 and at least one cover 4, all centered on a normally upright axis A. The container side 2 is composed of a cylindrical inner wall 5 of sheet steel and a cylindrical outer wall 6 of sheet steel that is spaced coaxially inward from the inner wall 5. Heat-dissipating metal webs or elements 7 are arranged between the inner wall 5 and the outer wall 6 such that they abut the inner wall 5 as well as the outer wall 6 under prestress. The remainder of the intermediate space formed between the inner wall 5 and the outer wall 6 is filled with a concrete filler 8.

At the top of the container the inner wall 5 and the outer wall 6 are connected to one another by an annular steel ring 9 that is welded to the inner wall 5 and to the outer wall 6. The container floor 3 is composed of an inner floor panel 10 and an outer floor panel 11 that are also both of sheet steel. The inner floor panel 10 is welded to the inner wall 5 and the outer floor panel 11 is welded to the outer wall 6 and both floor panels 10 and 11 are planar and perpendicular to the axis A.

FIGS. 1 and 2, clearly show how the metal elements 7 between the inner wall 5 and the outer wall 6 consist of tubes of trapezoidal cross section which can be elastically deformed and are integrally over the axial length of the container side 2. Inner sections 12 of the tubes 7 extend angularly and have a part-cylindrical curvature that corresponds to the inner wall 5, and outer sections 13 that similarly are part-cylindrically arcuate and that engage the outer wall 6 in surface contact. FIG. 2 also shows that the tubes 7 are uniformly arrayed and held in place by axially extending guide strips 14 of flat steel that are fixed on an outer surface of the inner wall 5.

The surfaces in the interior of the container have a coating of a release agent for the concrete 8, here an epoxy resin-based lacquer. Thus it is possible to easily strip off the outer wall 6 and concrete 8 from the inner wall 5.

As shown in FIG. 3, heat-dissipating L-shaped copper connector elements 15 are arranged between the inner floor panel 10 and the outer floor panel 11 of the container floor 3. They are fixed to the inner floor panel 10 at one end, and their other ends are clamped to faces of radially extending wall sections 17 of the tubes 7 by means of copper clips 16 themselves fixed on the outer floor panel 11.

To manufacture the above-described transport/storage container, the inner wall 5 and the outer wall 6 are welded to the steel ring 9 and to the inner floor panel 10. The assembly is then inverted so that the steel ring 9 is sitting on the ground and the space between the walls 5 and 6 is upwardly open. Then the tubes 7 are elastically deformed by pressing apart the wall sections 17 that interconnect the sections 12 and 13 and the thus elastically deformed tubes 7 are inserted axially between the walls 6 and 6. The spreaders that elastically deform the tubes 7 are withdrawn so that the inner wall sections 12 press against the inner wall 5 and the outer sections 13 press against the outer wall 6 under prestress. The angled metal elements 15 for the container floor 3 with the metal clips 16 are then installed. After the filler is introduced, the container is sealed by welding on the outer floor panel 11.

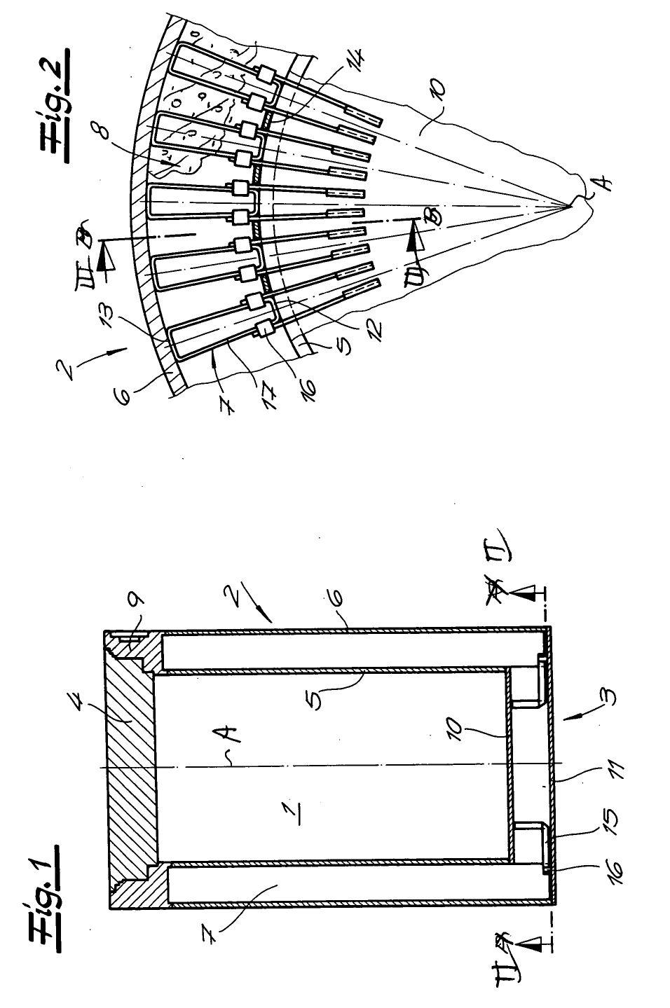

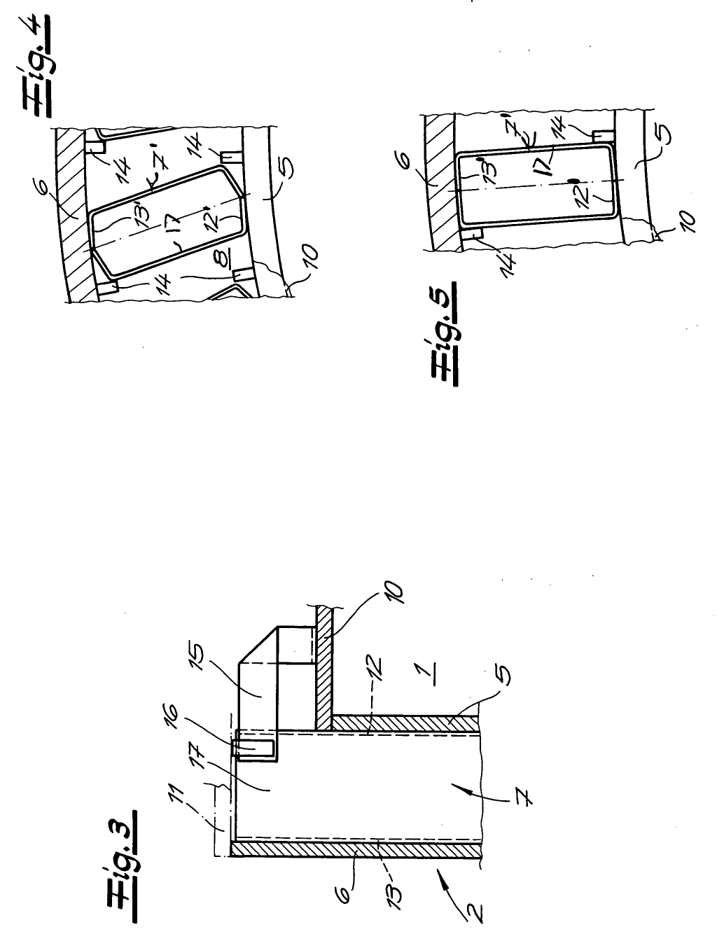

FIGS. 4 and 5 show a different embodiment of tubes 7′, in which a spreader is not required for installation. As shown in FIG. 4, the tubes 7′ that are of generally rectangular cross section when fully installed are shaped such that narrow tube wall sections 12′, 13′ that extend circumferentially of the container are V-shaped, formed of two parts meeting at a large obtuse angle of, for example, 160° before installation. Such tubes 7′ can be very inexpensively manufactured by spot welding generally U-shaped sheets. FIG. 4 shows how these tubes 7′ are inserted into the space between the walls 5 and 6, one part of each V-shaped wall section 12′ abuts the inner wall 5 and the diagonally opposite part of the outer section 13′ abuts the outer wall 6. As in FIGS. 1-3, axially extending and angularly equispaced guide strips 14 are welded to the inner and the wall 5 and 6.

Then according to the invention the inner wall 5 and outer wall 6 are turned relative to one each other bout the axis opposite to the angle of the tubes 7′. This action causes the guide strips 14 to exert a force upon the corners of the tubes 7′ such that the V-shaped wall sections 12′ and 13′ are bent inward. This causes the soft copper to adapt to uneven areas such that excellent surface contact is made between the sections 12′ and 13′ and the respective walls 5 and 6 for good transmission of heat therebetween. The force needed during this installation can be minimized by soft-annealing the V-shaped sections 12′ and 13′ of the tubes 7′. In the finished condition, as in FIGS. 2 and 3, the tube sections 17 extend in radial planes.

We claim:

1. A transport/storage container for heat-generating nuclear-fuel elements, the container comprising:
spaced inner and outer side walls defining an annular space extending along an axis and having upper and lower ends;
a cover at the upper end;
a floor at the lower end;
a plurality of axially extending and angularly spaced heat-conducting metal tubes each having an inner wall section bearing in surface contact on an outer surface of the inner side wall and an outer wall section bearing in surface contact on an inner surface of the outer side wall;
a filler mass in the space.

2. The transport/storage container defined in claim 1 wherein the tubes have radially extending wall sections that are elastically deformed.

3. The transport/storage container defined in claim 1 wherein the inner and outer wall sections of the tubes are soft annealed.

4. The transport/storage container defined in claim 1 wherein the tubes are of quadrilateral cross section.

5. The transport/storage container defined in claim 1 wherein each tube extends generally a full axial length of the space.

6. The transport/storage container defined in claim 1 wherein each of the inner and outer wall sections has a curvature complementary to a curvature of the respective inner and outer side wall.

7. The transport/storage container defined in claim 1 wherein the tubes are angularly equispaced, the container further comprising
axially extending and angularly spaced spacer strips fixed to the outer surface of the inner wall between the tubes.

8. The transport/storage container defined in claim 1 wherein the tubes are of generally rectangular section.

9. The transport/storage container defined in claim 1 wherein the inner and outer surfaces have a release-agent coating.

10. The transport/storage container defined in claim 9 wherein the coating is an epoxy lacquer.

11. The transport/storage container defined in claim 1 wherein the floor comprises an inner floor panel and an outer floor panel spaced axially therefrom and the tubes each have a pair of generally radially and axially extending wall sections, the container further comprising:
L-shaped connector strips each having one end fixed to an outer surface of the inner floor panel and an opposite end; and
respective clips securing the opposite ends to the radially extending wall sections of the tubes.
